(19) United States
(12) Patent Application Publication
(10) Pub. No.: US 2012/0284051 A1
(43) Pub. Date: Nov. 8, 2012

(54) METHOD AND SYSTEM FOR PERSONALIZING AND TRANSFORMING PATIENT INTERACTION RECORDS

(76) Inventors: Jimmy STANDAERT, Overland Park, KS (US); Josh PECK, Olathe, KS (US)

(21) Appl. No.: 13/416,846

(22) Filed: Mar. 9, 2012

Related U.S. Application Data
(60) Provisional application No. 61/450,999, filed on Mar. 9, 2011.

(51) Int. Cl. G06Q 50/24

(52) U.S. Cl. 705/3

(57) ABSTRACT

A system and method for personalization, and replication of diagnosis and treatment processes, with instruction, observations, and diagnosis is disclosed. Patient interaction steps such as prompting diagnosis inquiries, requesting diagnosis responses, recording the responses, revising diagnosis inquiries and generation of diagnosis report text, which is also revisable, draw on information from a global database to guide a medical professional through diagnosis. Revisions to diagnosis inquiries and diagnosis report text are saved in personalized databases and replicated for use by other medical professionals. The system is utilized within a particular practice site, and the practice site is in communication with a network of additional practice sites, central processor, and central databases. Revised patient interactions which prove more successful are replicated to for use by other medical professionals within the same practice site and at other practice sites.

### RELATED APPLICATIONS

The present U.S. non-provisional patent application is related to and claims priority benefit to an earlier-filed provisional patent application titled METHOD AND SYSTEM FOR PERSONALIZING AND TRANSFORMING PATIENT INTERACTION RECORDS, Ser. No. 61/450,999 and filed Mar. 9, 2011. The identified earlier-filed application is hereby incorporated by reference into the present application as though fully set forth herein.

### BACKGROUND

The present invention relates generally to systems and methods for collection, management, evaluation, guidance, personalization, and replication of subject matter expert analysis with personalized generation of instructions, observations, and conclusions based on subject matter expert analysis and, more particularly, to systems and methods for collection, management, evaluation, guidance, personalization, and replication of diagnosis processes by medical professionals with personalized generation of treatment instructions, observations, and diagnosis while preserving patient confidentiality and enabling medical professional best practices without undo interference with physician discretion and judgment.

Demands on medical professionals continue to increase with advances in medical knowledge and technology, confidentiality compliance and other government regulations, and administrative requirements to receive payment for services from insurance companies. Any failure to follow regulations, meet administrative requirements, maintain confidentiality, and keep up with advances may have serious financial and even punitive consequences for medical professionals. At the same time medical professionals struggle to maintain quality relationships with their patients and minimize the influence of regulatory and administrative requirements on what medical professionals believe to be the best treatments for patients.

In addition to advances in medical technology, medical professionals must also embrace advances in computer technology, which leads to additional regulations, confidentiality requirements, and requirements for Electronic Medical Records (EMR). For many medical professionals, the required transition to EMR is at best an inconvenience; however, even without a legal requirement to transition to EMR, the transition from International Statistical Classification of Diseases and Related Health Problems version 9 (ICD 9) to ICD-10, having substantially increased detail and number of codes, necessitates the transition to EMR. Therefore, medical professionals have embarked on the transition to EMR while struggling to maintain quality patient relationships, implement best treatment practices, and preserve patient confidentiality. One of the barriers to quality patient relationships is, of course, lack of time with the patients, and the repeated entry of similar instructions, observations, and treatments only takes additional time away from patients.

### SUMMARY OF THE INVENTION

There is, therefore, provided in the practice of the technology an adaptive diagnosis process and system for personalizing patient diagnosis during patient interactions. In the process, a patient is identified, and patient information including diagnosis information is recorded prompting a patient interaction step. In one aspect, the patient interaction step is a diagnosis inquiry. A diagnosis inquiry response is requested and recorded, and report text is generated based on the diagnosis inquiry response.

In the various aspects of the system, a processor is operable to carry out the process steps and access databases for required information. A display is provided for user interface. In one aspect, the processor is a mobile processor such as a tablet.

In one aspect, the technology is applicable to a diagnostic or trouble shooting process in which a subject for evaluation is identified. Evaluation subject information including diagnostic information is recorded prompting a subject interaction step. In one aspect, the subject interaction step is a diagnostic inquiry. A diagnostic inquiry response is requested and recorded, and report text is generated based on the diagnostic inquiry response.

In another aspect of the technology, an adaptive diagnosis process for personalizing patient diagnosis during patient interactions is provided in which a patient is identified, and patient information including diagnosis information is recorded prompting a diagnosis inquiry. A diagnosis inquiry response is requested and recorded, and report text is generated based on the diagnosis inquiry response. The diagnosis inquiry report text is revised to create a revised diagnosis inquiry report text, and the revised diagnosis inquiry report text is saved. In a further aspect, the diagnosis inquiring and report tests are revised, saved, and replicated for later use by the same medical professional and by different medical professionals.

In still another aspect of the technology, an adaptive diagnosis process for personalizing patient diagnosis during patient interactions and for determining and sharing best practices between medical professionals is provided in which a patient is identified, and patient information including diagnosis information is recorded prompting a diagnosis inquiry. A diagnosis inquiry response is requested and recorded. In one aspect, report text is generated based on the diagnosis inquiry response. The diagnosis inquiry response prompts a treatment guide providing a recommended treatment. Patient response to the recommended treatment is monitored, and based on improved patient response, the patient interaction steps, including in one aspect, the diagnosis inquiry and treatment guide, are prompted in a subsequent patient interaction by a different medical professional. In one aspect, at least one of the patient interactive steps such as the recommended treatment and diagnosis inquiry has been revised by a prior medical professional.

In an aspect of the technology, the revised recommended treatment and the revised diagnosis inquiry are replicated for use by different medical professionals in the same practice group and in different practice groups. Further the revised diagnosis inquiry and revised recommended treatment report text are used to generate a patient interaction report, and the medical professional revises the patient interaction report to create a revised patient interaction report which is saved for future use and replication to other medical professionals.

In another aspect of the technology, a first recommended treatment is presented to a first medical professional, and a second recommended treatment is presented to a second medical professional. The patients' responses to each of the recommended treatments are compared, and the recommended treatment with the most successful patient response is replicated to other medical professionals.

In a further aspect of the technology, an electronic medical records management and patient interaction management system providing an adaptive diagnosis process for personalizing patient diagnosis during patient interactions and for determining and sharing best practices between medical professionals includes a global pool diagnostic inquiries database, having global diagnostic inquiries, a global pool treatment guides database having global treatment guides and global recommended treatments, a plurality of personalized diagnostic inquiries databases with personalized diagnostic inquiries for a plurality of medical professionals, and a plurality of personalized pool treatment guides databases with personalized global treatment guides and personalized global recommended treatments for a plurality of medical professionals. The system also includes a processor operable to revise the global diagnostic inquires to successful personalized diagnostic inquiries and revise the global recommended treatments to successful personalized recommended treatments.

These and other features of the present invention are described in greater detail below in the section titled DETAILED DESCRIPTION.

### BRIEF DESCRIPTION OF THE DRAWING FIGURES

The present invention is described herein with reference to the following drawing figures, with greater emphasis being placed on clarity rather than scale:

FIG. 1 is a schematic diagram of a practice site according to the present invention;

FIG. 2 is a schematic diagram of a network of multiple practice sites according to the present invention;

FIG. 3 is a schematic diagram of databases according to the present invention;

FIG. 4 is a system process flow diagram according to the present invention;

FIG. 5 is an exemplary patient identification graphical user interface according to the present invention;

FIG. 6 is an exemplary diagnosis inquiry prompting and recording graphical user interface according to the present invention;

FIG. 7 is an exemplary diagnosis inquiry prompting and recording graphical user interface according to the present invention;

FIG. 8 is an exemplary diagnosis inquiry prompting and recording graphical user interface having a diagnosis image according to the present invention;

FIG. 9 is an exemplary diagnosis inquiry prompting and revisable diagnosis report text generation graphical user interface with a text editor according to the present invention;

FIG. 10 is an exemplary diagnosis inquiry prompting and revisable diagnosis report text generation graphical user interface with a text editor according to the present invention;

FIG. 11 is an exemplary treatment guide and recommended treatments and revisable recommended treatment report text generation graphical user interface with a text editor according to the present invention;

FIG. 12 is an exemplary diagnosis inquiry prompting and revisable diagnosis report text generation graphical user interface according to the present invention;

FIG. 13 is an exemplary patient interaction report graphical user interface with a text editor according to the present invention;

FIG. 14 is an exemplary patient interaction report graphical user interface illustrating output options according to the present invention, and

FIG. 15 is a system process flow diagram according to the present invention.

### DETAILED DESCRIPTION

With reference to the drawing figures, an adaptive diagnosis process and system for personalizing patient diagnosis and treatment during patient interactions and sharing best practices between medical professionals is herein described, shown, and otherwise disclosed in accordance with various aspects, including a preferred embodiment, of the present invention.

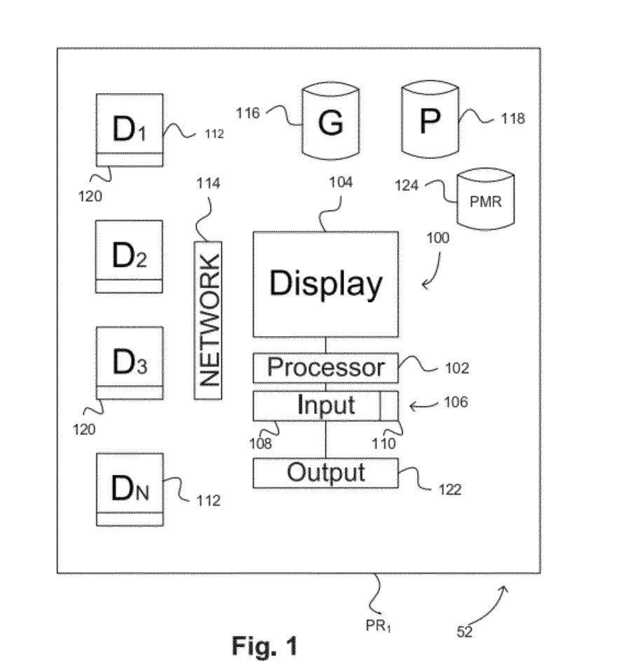

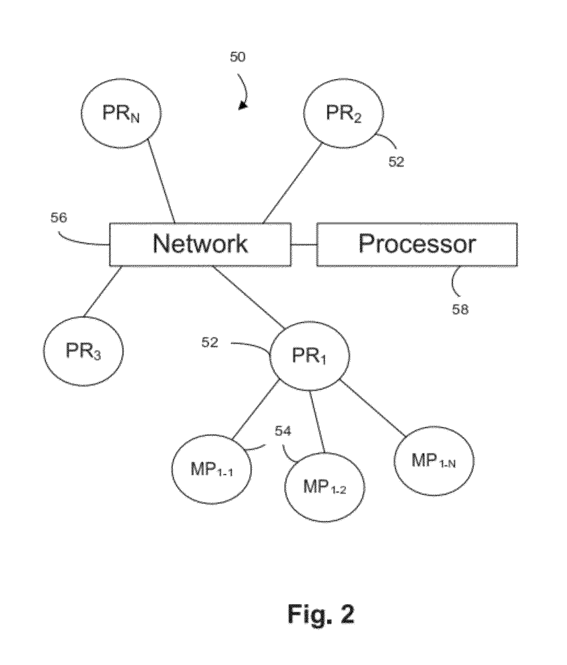

Referring now to the Figures of the Drawing, wherein like reference numerals designate identical or corresponding parts throughout the several views, and more particularly to FIG. 1, a global diagnosis system 50 (FIG. 2) includes a medical professional practice site system 52 labeled PR₁ including a computer 100 having a processor 102, display 104, and input device 106 having, in one aspect, a keyboard component 108, and a pointer or mouse component 110. The system also includes a plurality of medical professional interface devices 112 identified as D₁, D₂, D₃, and D_{N}. The interface devices 112 are mobile computers such as tablets with mobile processors 120. In other aspects of the technology, the interface devices are handhelds, laptops, full computer systems on wheeled carts, and personal digital assistants (PDA). In another aspect, the interface devices 112 are computer systems generally fixed in each exam room and in communication with the processor 102. The interface devices 112 are in communication with the computer 100 through network 114. The network 114 is wired in one aspect and wireless in another. The network 114 comprises, in various aspects, a Local Area Network (LAN), Wide Area Network (WAN), and internet. The processor is also in communication with a local global database 116 labeled G and a local personalized database 118 labeled P. While the databases referenced throughout are identified separately, a unitary database structure is utilized in one aspect of the technology. The local global database 116 contains a local global diagnostic inquiries database having local global diagnostic inquiries for prompting to medical professionals during patient interactions. The diagnostic inquiries database includes diagnosis prompts for each potential disease and injury under ICD 10 enabling a medical professional to evaluate the 7 body areas and 12 organ systems for the purposes of physical examination. Medical codes are suggested from an existing database of codes and coding types to simplify the medical coding process. The local global database 116 also includes a local global treatment guides database having recommended treatments for prompting to medical professionals during patient interactions. The computer 100 also includes an output 122, which in various aspects comprises a printer, an electronic transmission such as e-mail, and electronic transmission such as posting to a secured web site.

Referring additionally to FIG. 2, the system 50 includes a plurality of medical professional practice sites 52 labeled PR₁, PR₂, PR₃, and PR_{N}. Each of the practice site systems 52 provides a plurality of medical professional interfaces 54 labeled MP₁₋₁, MP₁₋₂, and MP_{1-N} corresponding to the medical professional interface devices 112. A sufficient number of interfaces 54 and devices 112 are provided for the number of medical professionals actively practicing at a given practice site. The practice sites 52 are in communication with a central network 56 and a central processor 58. The central processor 58 is provided as part of a computer such as computer 100 having similar components (display, input, and output) to computer 100. In one aspect, the central network 56 is the internet, and in other aspects, the central network is a LAN or WAN.

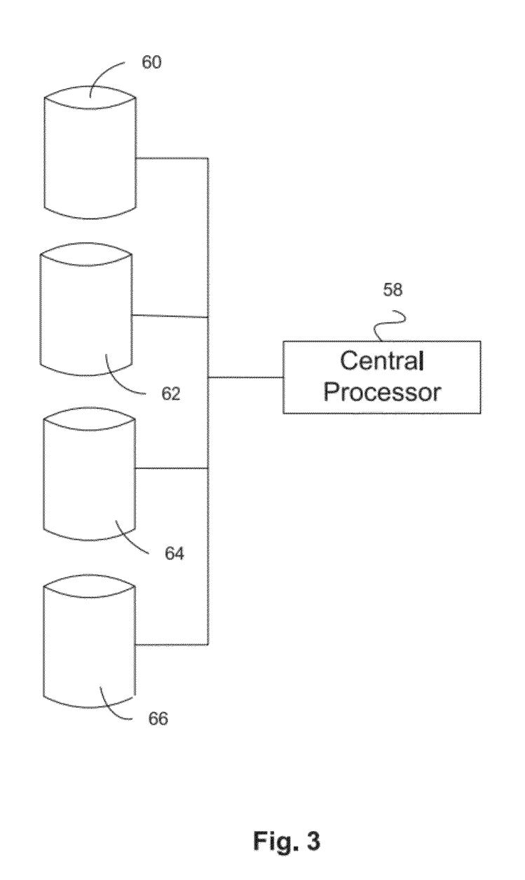

Referring additionally to FIG. 3, the central processor 58 is in communication with a central global diagnostic inquiries database 60, a central global treatment guides database 62, a central personalized diagnostic inquiries database 64, and a central personalized treatment guides database 66. The central diagnostic database 60 includes diagnostic inquiries used to populate the local diagnostic inquiries databases 116. The central treatment guides database is used to populate the local treatment guides databases 118 and contains recommend treatments for each potential disease and injury.

It is understood that the computer 100, the central processor 58, and the interface devices 112 also include additional components as required by the specific implementation of the technology. Therefore, in various aspects, the computer includes servers, communication mechanisms such as modems and routers, additional processors, memory such as random access memory (RAM) and dynamic RAM (DRAM), storage such as hard drives, removable media such as floppy drives and CD drives, connection ports such as Universal Serial Bus (USB) and Category 5 (CAT 5) for twisted pair cable. Further, the input device 106 uses touch screen technology for an electronic keyboard and a stylus for user convenience. The computer 100 includes computer readable medium such as compact discs, hard disks, floppy discs, magneto-optical disks, transmission media such as coaxial cables and twisted pair, and memory.

The process implemented on the system utilizes the Subjective, Objective, Assessment, Plan (SOAP) method of documentation employed by medical professionals to write out notes in a patient care chart. In other aspects of the technology other diagnosis and documentation methods are employed such as diagnosis by exception. Documenting patient interactions in the medical record is an integral part of practice workflow starting with patient appointment scheduling, to writing notes and to medical billing. As used herein, medical professionals includes physicians, nurses, nurse practitioners, dentists, dental hygienists, opticians, pharmacists, technicians, physical therapists, and others, and any reference to one includes all.

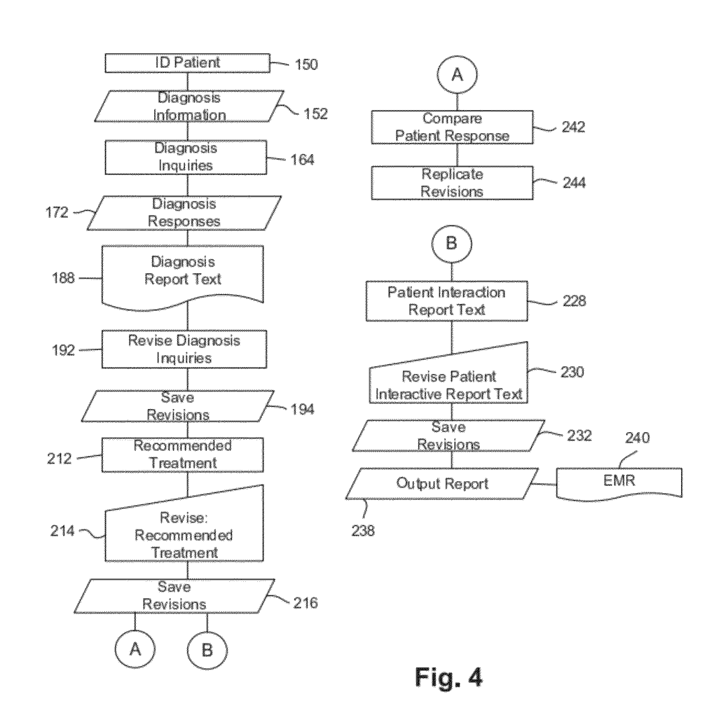

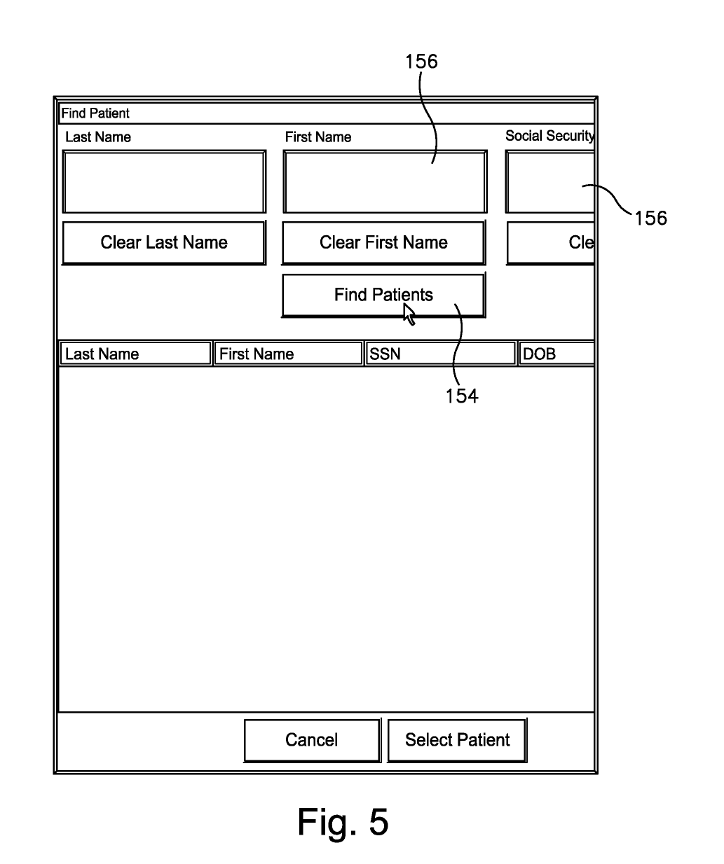

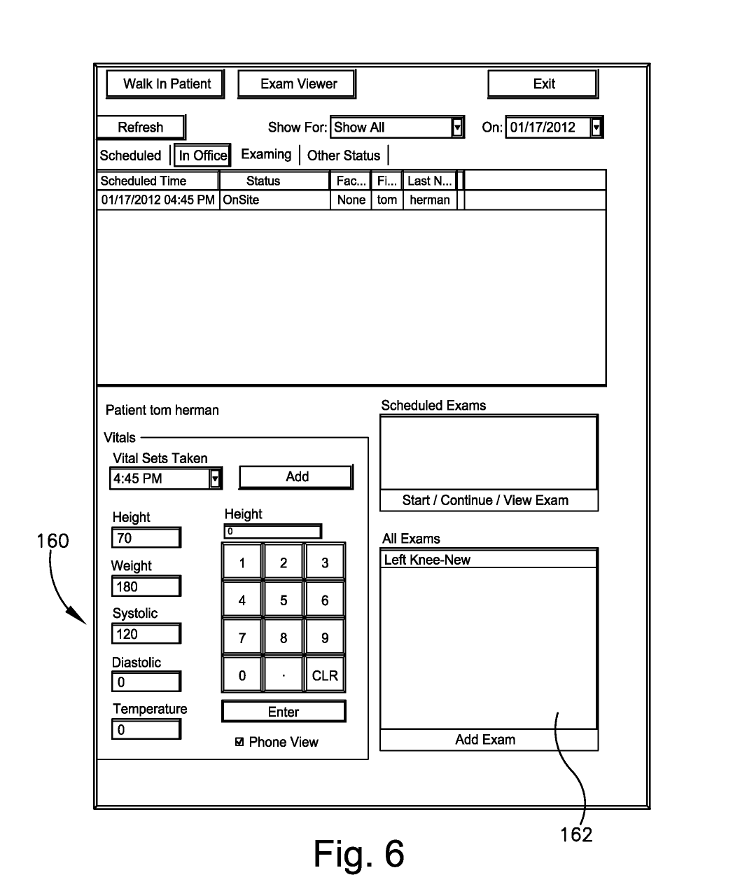

Referring to FIG. 4 and FIG. 5, the first step in the process is for the physician or nurse to login providing identification and security information. Following login, the nurse will engage in several patient interaction steps beginning with a search to identify the patient 150 and pull up the patient record. Alternatively, new patient information is entered into the Patient Medical Records (PMR) database 124 (FIG. 1). This includes identifying and selecting a record stored in the PMR database 124 for an existing patient either scheduled or unscheduled or for a new patient scheduled or walking in to the office without a prior appointment. The search procedure is initiated by selecting Find Patients 154 and entering a name or social security number into name and social security search fields 156, 158. Typically, a nurse will take initial patient diagnosis information 152 as a next patient interaction step such as vital signs and record the diagnosis inquiry responses into response fields 160, in this example for vital signs, as demonstrated in FIG. 6. Unless specifically noted no claim or description is limited to any specific order. The Nurse may also request what condition has caused the patient to seek medical care, which will guide the nurse or physician to selection by prompting with a diagnosis inquiry of an exam type 162. Additionally, the interface devices will prompt the collection of patient information such has primary care physician, occupation, employer, insurance, and others to be recorded on Registration Forms displayed by the interface device/tablet 52. The Registration Forms are specific to the practice site 52 in one aspect, and can be replicated to other practice sites. Following the initial diagnosis information, the process and system will select and prompt the appropriate diagnosis inquiry. In the example provided, a left knee analysis is used to provide a context for explanation of the technology and invention. However, it is understood that the technology and invention are applicable to all recognized disease and injuries.

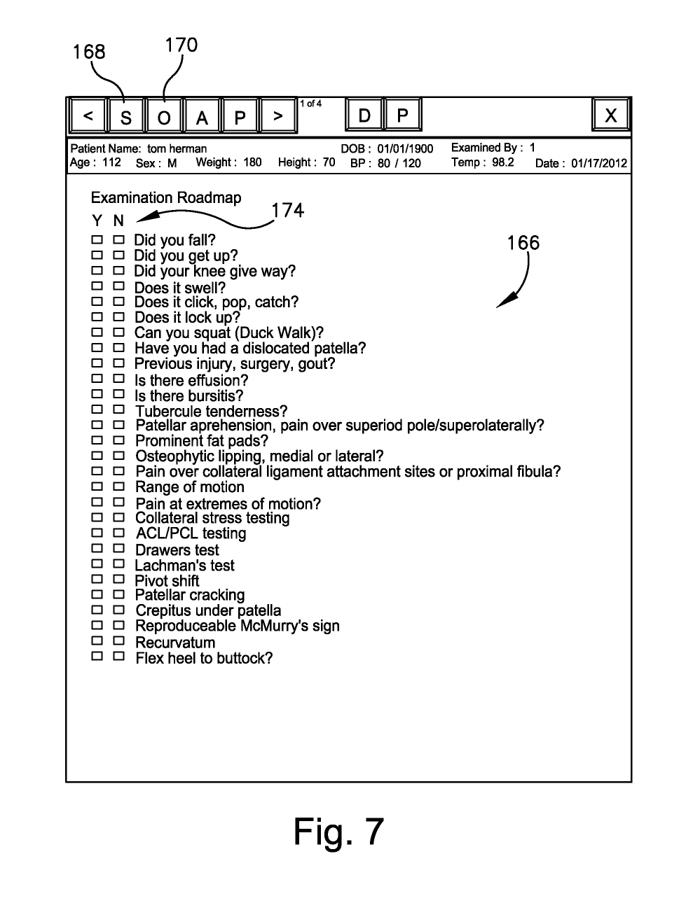

Referring to FIG. 4 and FIG. 7, he user then moves from the Subjective phase of the process performed under the S tab 168 to the Objective phase under the O tab 170. The user can record additional information under the S tab 168 by selecting the S tab and selecting the appropriate field for entering the additional information. The user then selects the O tab 170 to move back to the Objective phase, in which a specific diagnosis inquiry is generated at 164, and the interface device 112 displays a prompting 166 of diagnosis questions. The physician enters and the tablet 112 records at 172 the diagnosis responses 172 on the interface device 112 with an input, such as a stylus, touch screen, or mouse. Further, though FIG. 4 is shown in the form of a flow diagram, it is understood under the architecture of the present program and process that the physician can move from one process step to another without following a particular order.

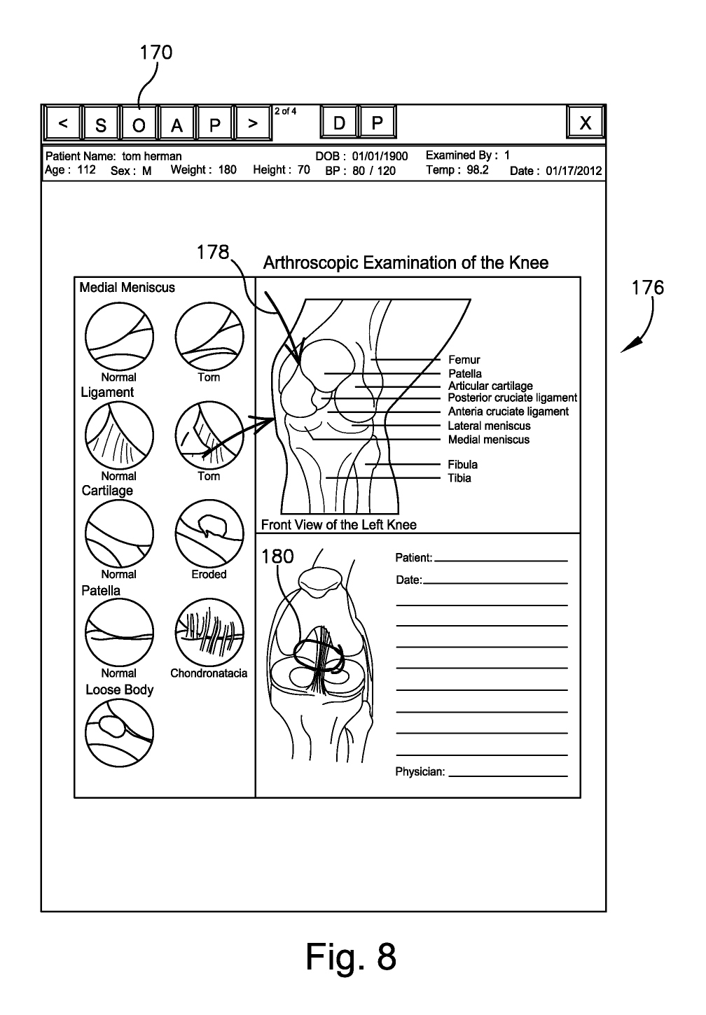

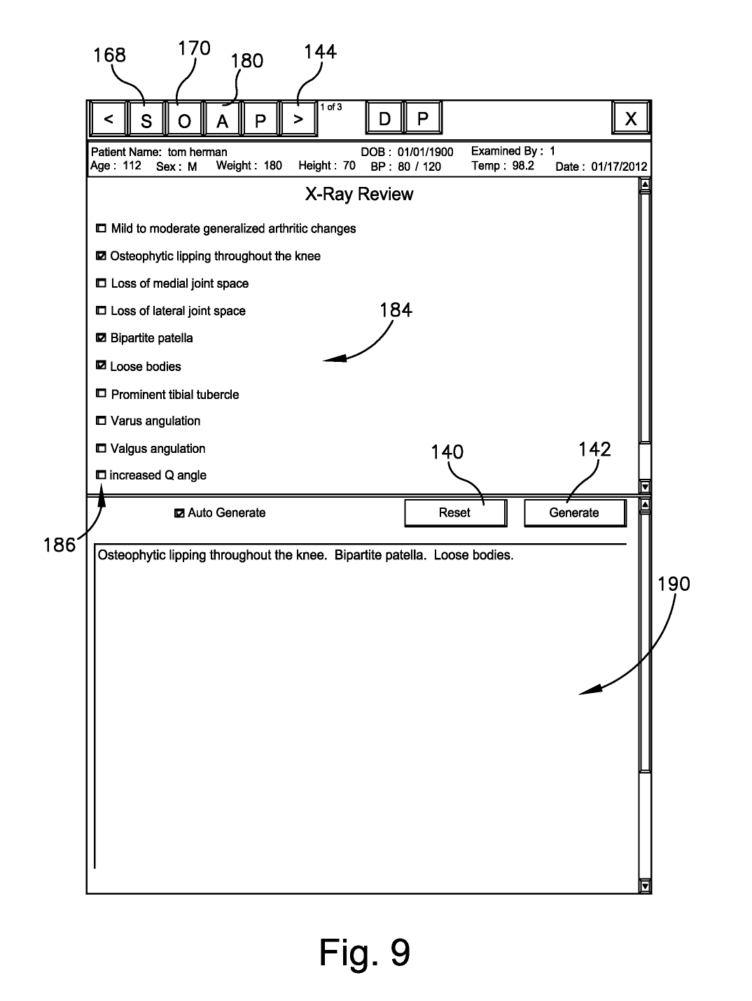

Referring additionally to FIG. 8, a graphic diagnosis inquiry 176 from the diagnosis inquiry databases 116, 118 is utilized for selected examinations. The tablet 112 is operable to record diagnosis responses such as notes and graphical indicators 178, 180 of injury type and location. Further, prompting of diagnosis inquiries is illustrated in FIG. 9 under the Assessment tab 182. Again the tablet 112 is operative to selectively move from the diagnosis inquiries under the O tab 170 to the diagnosis inquiries under the A tab 182 and back as required by the medical professional during recording 172 (FIG. 4) of diagnostic responses. X-Ray diagnosis inquiries 184 are provided with a check box 186 diagnosis response format, and as check boxes 186 are selected or unselected, diagnosis report text is generated 188 in a text editor field 190. The physician selects the diagnosis report text populated from the global database 116 by checking and unchecking check boxes, and revises 192 the diagnosis report text by typing in or deleting text with the text editor 190. The physician user may clear the report text and check boxes by selecting the reset button 140, and the text editor 190 is enabled by selecting the generate button 142 or clicking in the text editor field 190. The report text will auto generate and save when the next button 144 is selected. Based on the physician's analysis of the diagnosis process and the patient's diagnosis responses, the physician revises 192 the diagnosis inquiries to improve the diagnostic process. The revisions 192 to the diagnosis inquiries and the diagnosis report text are saved 194 in the personalized database 118 corresponding to the medical professional conducting the exam.

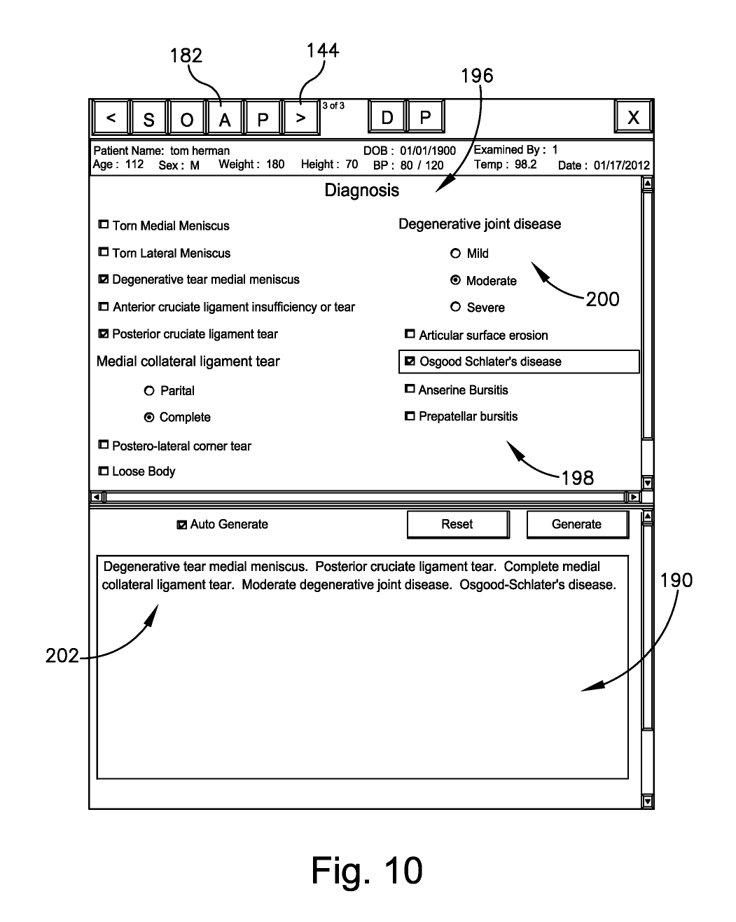

Similarly, referring additionally to FIG. 10, a set of final diagnosis inquiries 196 with both check box 198 and radio button 200 formats are checked and selected to generate 188 additional diagnosis report text 202, which is displayed and revisable in the text editor 190.

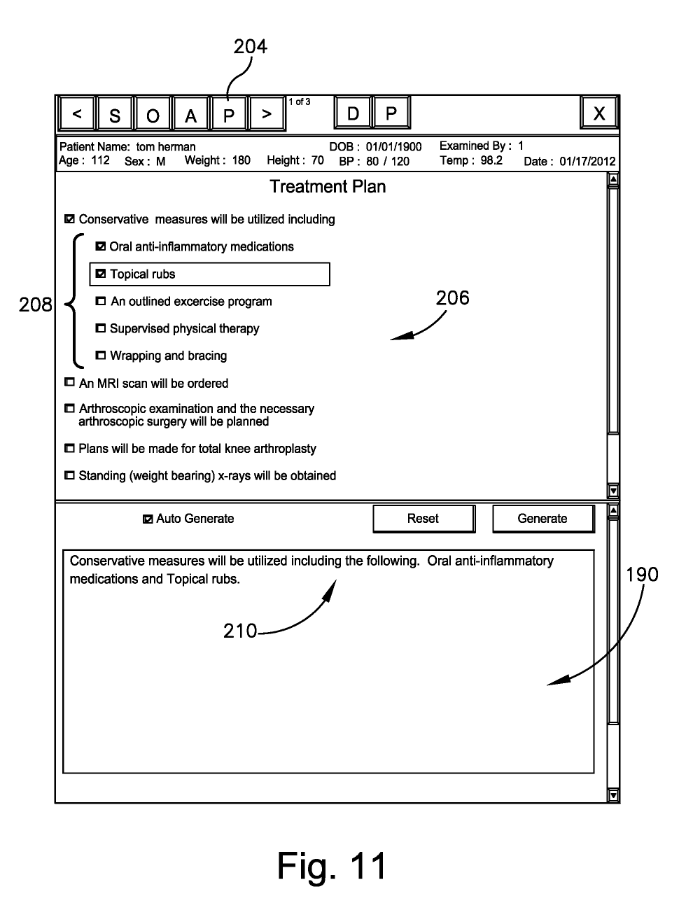

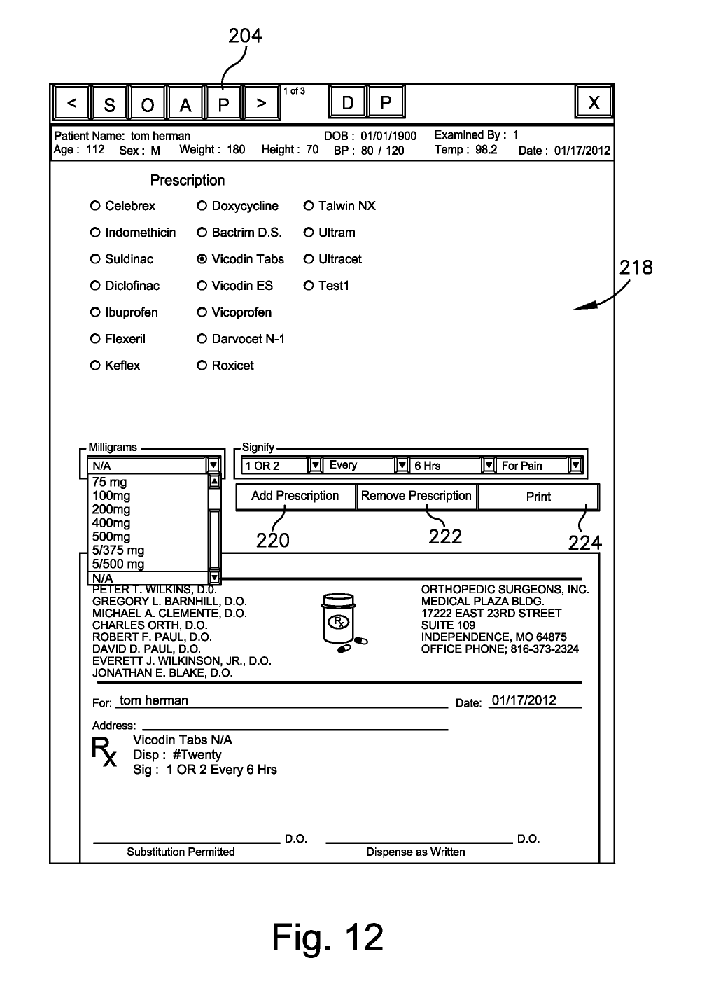

Proceeding to the Plan phase under the P tab 204 with reference to FIG. 4 and FIG. 11, the treatment guide with recommended treatments 206 are prompted from the global database 116 for display on the interface device 112. As with the diagnosis, the physician selects treatments from the recommended treatments 206 including sub-group treatments 208. The recommended treatment report text 210 is generated 212, and the physician can revise the recommended treatment report text at 214, which is saved 216 to the personalized database 118. Referring additionally to FIG. 12, the treatment guide proceeds to display a prescriptions prompt 218 as part of the recommended treatment plan enabling the physician to select appropriate pharmaceuticals together with the appropriate dosage and frequency. The physician may select the add button 220 to prescribe multiple pharmaceuticals, and the physician selects the remove button 222 to delete a prescription. If desired, the physician selects the print button 224, to output or print the prescriptions without proceeding to generation 228 of the patient interaction report text 226 discussed below.

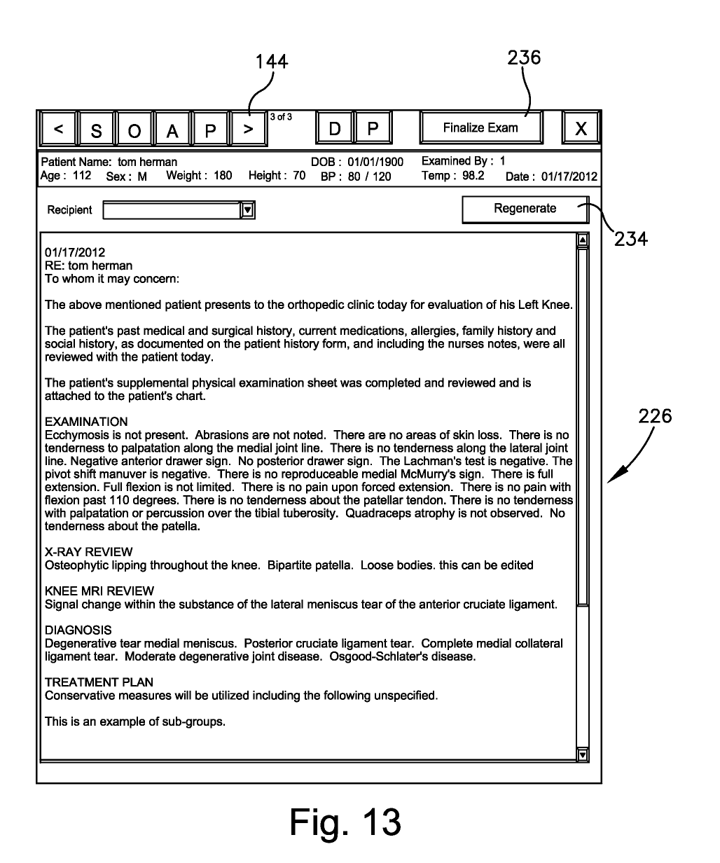

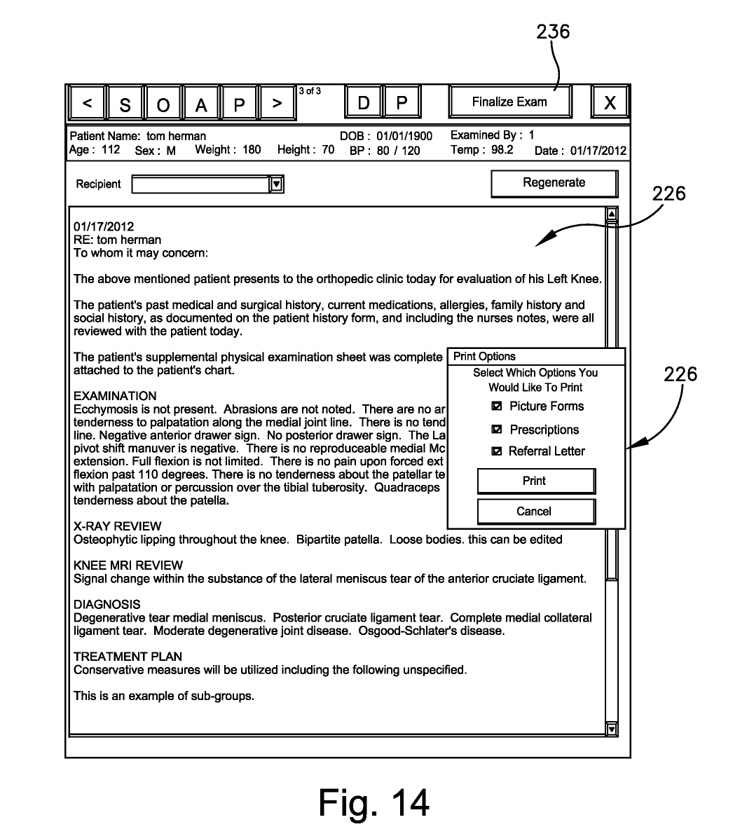

Referring to FIG. 4 and FIG. 13, the process then, when the next button 144 is selected, generates at 228 the patient interaction report text 226 in the form of a report or letter. Again the physician revises 230 the report text 226, and the revised report is saved 232 in the personalized database 118 and associated with the revising medical professional. If the physician desires to return to the patient interaction report text without any revisions, the regeneration button 234 is selected. Referring additionally to FIG. 14, once the physician is satisfied with the report, the finalize exam button 236 is selected, and the process will proceed to output 238. The output 238 includes generating a memo for a file, a letter for transmission electronically or on paper, and posting to a secure web site. In general, the output 238 produces an Electronic Medical Record (EMR) 240. The output also presents print options 242 to the physician. Within the practice site 52, the revisions made by the physician and saved to the personalized database 118 can be replicated to the global database 116. The revised diagnosis inquiry, revised recommended treatment, revised diagnosis report text, revised recommended treatment report text, and the resulting revised patient interaction report text are then provided to the devices 112 for prompting and generation during subsequent examinations conducted by different medical professionals within the same practice site. The replication occurs in response to a decision by the physicians to replicate the revised exam components, and the replication also occurs in response to observation of patient responses to revised recommended treatment. When an improved patient response is observed, the revised exam components are replicated within the practice site 52.

Similarly, with reference again to FIG. 2, FIG. 3, and FIG. 4, the revised exam components are transmitted via network 56 and saved in the central personalized databases 64, 66. Patient responses to the revised exam components are monitored at practice sites, and the results are transmitted via the network 56 to the central processor 58 where they are compared 242 to patient responses from other personalized exam components and the global exam components. When an improved patient response is observed, the successful personalized exam components are replicated 244 to the global databases 60 62 for use by physicians at other practice sites that are different from the practice site developing the personalized exam components. The replication decision is also based on a professional determination by physicians that a given diagnosis process or recommended treatment should be replicated to the global databases 60, 62 for use by other physicians.

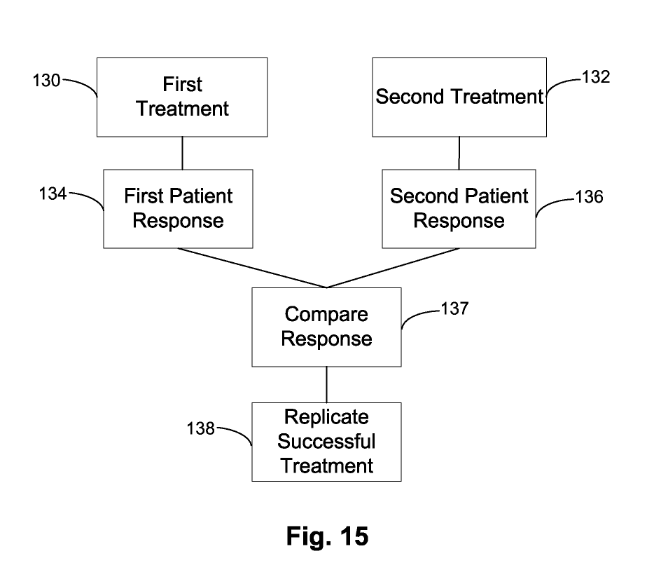

In another aspect of the technology and with reference to FIG. 15, the process includes prompting 130 a first treatment guide with a first recommended treatment to a first physician examining a first patient and prompting 132 a second treatment guide with a second recommended treatment to a second physician examining a second patient. The first patient's response is monitored 134 and recorded, and the second patient's response is monitored 136 and recorded. The patient responses are compared 137, and the more successful recommended treatment is replicated 138 for prompting to other physicians, including the physician that provided the less successful initial recommended treatment. The first and second physicians are in the same practice group in one aspect and in different practice groups at different practice sites 52 in another aspect utilizing the central network 56 for communication and the central processor 58 for comparison. The process also utilizes multi physicians for each of the recommended treatments to broaden patient responses for comparison. Further process compares more than two recommended treatments in another aspect.

In another aspect of the invention, the process is applied in non-medical diagnostic environments wherein a correction report is generated. The process includes identifying a subject for evaluation, recording subject information including diagnostic information, prompting a diagnostic inquiry, requesting a diagnostic inquiry response to the diagnostic inquiry, recording the diagnostic inquiry response, and generating diagnostic report text. The processor then prompts recommended corrective actions and generates corrective action report text. The diagnostic report text and corrective action report text are used in combination with other report text to generate a subject interactive report text. The diagnostic inquiry, recommended corrective action, report texts are revised and saved for future replication to other the same technician and different technicians.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. An adaptive diagnosis process for personalizing patient diagnosis during patient interactions and sharing best practices between medical professionals, the process comprising:
a. identifying a patient;
b. recording patient information including diagnosis information;
c. prompting a diagnosis inquiry;
d. requesting a diagnosis inquiry response to the diagnosis inquiry;
e. recording the diagnosis inquiry response;
f. generating diagnosis report text based on the diagnosis inquiry response.

2. The diagnosis process of claim 1 further comprising prompting a follow up diagnosis inquiry based on the diagnosis inquiry response, and recording a follow up diagnosis response.

3. The diagnosis process of claim 1 further comprising revising the diagnosis inquiry to create a revised diagnosis inquiry, and saving the revised diagnosis inquiry.

4. The diagnosis process of claim 3 further comprising prompting the revised diagnosis inquiry in a subsequent patient examination by a different medical professional.

5. The diagnosis process of claim 3 further comprising prompting the revised diagnosis inquiry in a subsequent patient examination by a different medical professional in a different medical professional group.

6. The diagnosis process of claim 1 further comprising generating a patient interaction report including the diagnosis report text.

7. The diagnosis process of claim 1 further comprising prompting a treatment guide.

8. The diagnosis process of claim 1 further comprising revising the diagnosis report text to create a revised diagnosis report text, and saving the revised diagnosis report text.

9. The diagnosis process of claim 1 further comprising prompting a diagnosis inquiry image form, and recording a diagnosis inquiry image form response including marking diagnosis indications on the diagnosis inquiry image form.

10. An electronic medical records management and patient interaction management system for guiding a medical professional through a patient interaction, the system comprising:
a. a processor and a display enabling an operator to identify a patient and record patient information;
b. the processor operable to prompt a diagnosis inquiry and enable the operator to record a diagnosis inquiry response;
c. the processor operable to generate diagnosis report text based on the diagnosis inquiry response.

11. The system of claim 10 wherein the processor comprises a mobile processor.

12. Computer readable medium including instructions for an adaptive diagnosis process for personalizing patient diagnosis during patient interactions and sharing best practices between physicians, the instructions implementing steps comprising:
a. identifying a patient;
b. recording patient information including diagnosis information;
c. prompting a diagnosis inquiry;
d. requesting a diagnosis inquiry response to the diagnosis inquiry;
e. recording the diagnosis inquiry response;
f. revising the diagnosis inquiry to create a revised diagnosis inquiry, and
g. saving the revised diagnosis inquiry.

13. An adaptive diagnosis process for personalizing patient diagnosis during patient interactions and for determining and sharing best practices between medical professionals, the process comprising:
a. identifying a patient;
b. recording patient information including diagnosis information;
c. prompting a diagnosis inquiry;
d. requesting a diagnosis inquiry response to the diagnosis inquiry;
e. recording the diagnosis inquiry response;
f. prompting a treatment guide providing a recommended treatment;
g. monitoring patient response to the recommended treatment, and
h. based on improved patient response to the recommended treatment, prompting the diagnosis inquiry, treatment guide, and recommended treatment in a subsequent patient examination by a different medical professional.

14. The process of claim 13 wherein prompting the treatment guide comprises prompting a first approach treatment guide with a first recommended treatment to a first medical professional, and further comprising prompting a second approach treatment guide with a second recommended treatment to a second medical professional, and further comprising comparing patient response between the first approach treatment guide and the second approach treatment guide.

15. The process of claim 13 further comprising revising the treatment guide to create a revised treatment guide and revised recommended treatment, saving the revised treatment guide, monitoring patient response to the revised recommended treatment, and based on improved patient response, prompting the diagnosis inquiry and revised treatment guide in a subsequent patient examination by a different medical professional.

16. An electronic medical records management and patient interaction management system providing an adaptive diagnosis process for personalizing patient diagnosis during patient interactions and for determining and sharing best practices between medical professionals, the system comprising:
a. a global diagnostic inquiries database, including global diagnostic inquiries;
b. a global treatment guides database including global treatment guides and global recommended treatments;
c. a plurality of personalized diagnostic inquiries databases, including personalized diagnostic inquiries for a plurality of medical professionals;
d. a plurality of personalized treatment guides databases including personalized treatment guides and personalized recommended treatments for a plurality of medical professionals, and
e. a processor operable to revise the global diagnostic inquires to successful personalized diagnostic inquiries and revise the global recommended treatments to successful personalized recommended treatments.

17. The system according to claim 15 wherein the processor is further operable to monitor patient response to personalized diagnostic inquiries, and monitor patient response to personalized recommended treatments.

18. An adaptive diagnosis process for generating a correction report and sharing best diagnostic practices with other technicians, the process comprising:
a. identifying a subject for evaluation;
b. recording subject information including diagnostic information;
c. prompting a diagnostic inquiry;
d. requesting a diagnostic inquiry response to the diagnostic inquiry;
e. recording the diagnostic inquiry response;
f. generating diagnostic report text based on the diagnostic inquiry response.

19. An adaptive diagnosis process for personalizing patient diagnosis during patient interactions, the process comprising:
a. identifying a patient;
b. recording patient information including diagnosis information;
c. prompting a diagnosis inquiry;
d. requesting a diagnosis inquiry response to the diagnosis inquiry;
e. recording the diagnosis inquiry response;
f. generating a diagnosis inquiry report text;
g. revising the diagnosis inquiry report text to create a revised diagnosis inquiry report text, and saving the revised diagnosis inquiry report text.

20. The process of claim 19 further comprising generating a patient interaction report text including the revised diagnosis inquiry report text, revising the interaction report text to create a revised patient interaction report text, and saving the revised patient interaction report text.

21. The process of claim 19 further comprising prompting a treatment guide, generating treatment guide report text; revising the treatment guide report text to create a revised treatment guide report text, and saving the revised treatment guide report text.

22. The process of claim 19 further comprising prompting a recommended treatment, generating recommended treatment report text; revising the recommended treatment report text to create a revised recommended treatment report text, and saving the revised recommended treatment report text.
